(19) United States
(12) Patent Application Publication
(10) Pub. No.: US 2024/0275558 A1
(43) Pub. Date: Aug. 15, 2024

(54) DEPENDENCY OF UCI TYPE ON UCI MULTIPLEXING WITH OVERLAPPING PUSCH

(71) Applicant: QUALCOMM Incorporated, San Diego, CA (US)

(72) Inventors: Yitao CHEN, San Marcos, CA (US); Mostafa KHOSHNEVISAN, San Diego, CA (US)

(21) Appl. No.: 18/434,626

(22) Filed: Feb. 6, 2024

Related U.S. Application Data
(60) Provisional application No. 63/485,242, filed on Feb. 15, 2023.

(51) Int. Cl. H04L 5/00; H04L 1/1607; H04L 1/1812

(52) U.S. Cl. CPC H04L 5/0053; H04L 1/1621; H04L 1/1812

(57) ABSTRACT

Method and apparatus for multiplexing UCI with overlapping PUSCH based on a UCI type. The apparatus receives a configuration for multiple DCI operation including associations with CORESETs configured for the UE, the associations including CORESET pool index 0 or an absence of a CORESET pool index, and CORESET pool index 1. The apparatus transmits UCI multiplexed with a PUSCH from multiple overlapping PUSCHs that overlap in a time domain on a same carrier and overlap in the time domain with the UCI, the multiplexing being based on at least one of a type of the UCI, content of the UCI, a feedback mode or a carrier configuration.

### CROSS REFERENCE TO RELATED APPLICATION(S)

This application claims the benefit of and priority to U.S. Provisional Application Ser. No. 63/485,242, entitled “Dependency of UCI Type on UCI Multiplexing with Simultaneous PUSCH” and filed on Feb. 15, 2022, which is expressly incorporated by reference herein in its entirety.

### TECHNICAL FIELD

The present disclosure relates generally to communication systems, and more particularly, to a configuration for multiplexing uplink control information (UCI) with simultaneous physical uplink shared channel (PUSCH) based on a UCI type.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a configuration for multiple downlink control information (DCI) operation including associations with control resource sets (CORESETs) configured for the UE, the associations including CORESET pool index 0 or an absence of a CORESET pool index, and CORESET pool index 1. The apparatus transmits uplink control information (UCI) multiplexed with a physical uplink shared channel (PUSCH) from multiple overlapping PUSCHs that overlap in a time domain on a same carrier and overlap in the time domain with the UCI, the multiplexing being based on at least one of a type of the UCI, content of the UCI, a feedback mode or a carrier configuration.

In an aspect of the disclosure, a method, a computer-readable medium, and an apparatus are provided. The apparatus may be a device at a network node. The device may be a processor and/or a modem at a network node or the network node itself. The apparatus provides configuration for multiple downlink control information (DCI) operation for a user equipment (UE) including associations with control resource sets (CORESETs) configured for the UE, the associations including CORESET pool index 0 or an absence of a CORESET pool index, and CORESET pool index 1. The apparatus receives uplink control information (UCI) multiplexed with a physical uplink shared channel (PUSCH) from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of UCI multiplexing.

FIG. 5 is a diagram illustrating an example of UCI multiplexing.

FIG. 6 is a diagram illustrating an example of HARQ-ACK for multi-DCI.

FIG. 7 is a diagram illustrating an example of overlapping PUSCHs.

FIG. 8A-8B are diagrams illustrating examples of UCI multiplexing based on a component carrier configuration.

FIG. 9 is a call flow diagram of signaling between a UE and a base station.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a flowchart of a method of wireless communication.

FIG. 14 is a diagram illustrating an example of a hardware implementation for an example network entity.

### DETAILED DESCRIPTION

In wireless communications, certain multiplexing rules may be utilized to resolve a collision or time overlap between different uplink channels, such as in instances where PUSCH and PUCCH collide or when PUCCH and another PUCCH collide. Collisions between PUCCH and another PUCCH may be due to carrying different data or payloads. In these instances, under an assumption of joint timelines, multiple UCIs may be multiplexed on a PUCCH or on a PUSCH. The determination of which PUSCH to select for UCI multiplexing in instances where multiple PUSCHs are in one or more component carriers overlapping with the UCI may impact the manner in which PUSCH is selected for multiplexing with UCI due in part to multiple PUSCHs in the same component carrier.

Aspects presented herein provide a configuration for multiplexing UCI with overlapping PUSCH based on at least one of a UCI type, the mode of the feedback, or a configuration of a PUCCH-cell. At least one advantage of the disclosure is that such factors may allow for selection of a PUSCH to multiplex with UCI. In some aspects, the factors may determine whether the UCI is associated with a CORESET Pool Index or not, and may assist in determining whether it is acceptable to multiplex UCI on a PUSCH towards any TRP or to specific TRPs or not.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

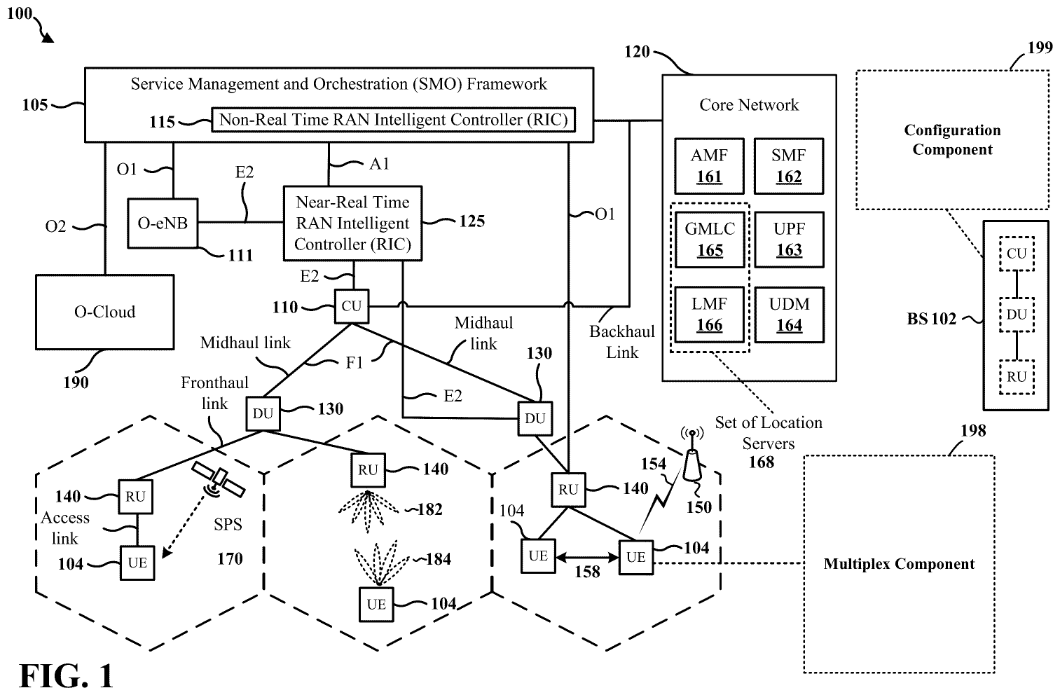

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a multiplex component 198 configured to receive a configuration for multiple DCI operation including associations with CORESETs configured for the UE, the associations including CORESET pool index 0 or an absence of a CORESET pool index, and CORESET pool index 1; and transmit UCI multiplexed with a PUSCH from multiple overlapping PUSCHs that overlap in a time domain on a same carrier and overlap in the time domain with the UCI, the multiplexing being based on at least one of a type of the UCI, content of the UCI, a feedback mode or a carrier configuration.

Referring again to FIG. 1, in certain aspects, the base station 102 may comprise a configuration component 199 configured to provide configuration for multiple DCI operation for a UE including associations with CORESETs configured for the UE, the associations including CORESET pool index 0 or an absence of a CORESET pool index, and CORESET pool index 1; and receive UCI multiplexed with a PUSCH from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

Although the following description may be focused on 5G NR, the concepts described herein may be applicable to other similar areas, such as LTE, LTE-A, CDMA, GSM, and other wireless technologies.

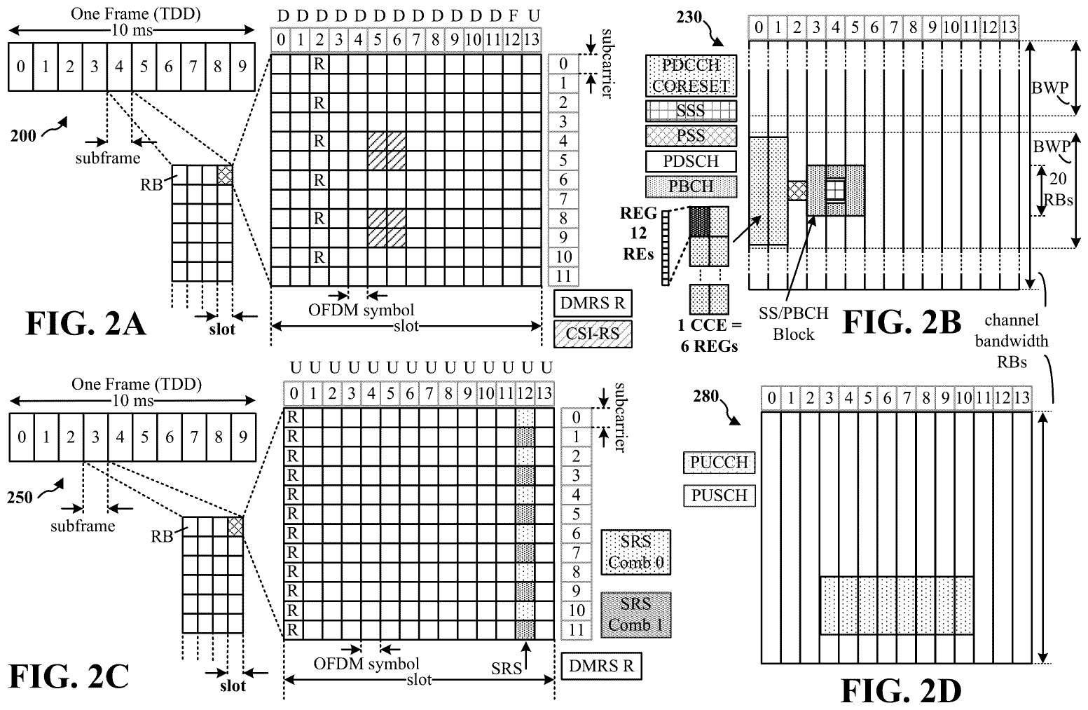

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 6 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2*15 kHz, where y is the numerology 0 to 6. As such, the numerology p=0 has a subcarrier spacing of 15 kHz and the numerology p=6 has a subcarrier spacing of 960 kHz. The symbol length/duration is inversely related to the subcarrier spacing. FIGS. 2A-2D provide an example of normal CP with 14 symbols per slot and numerology p=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

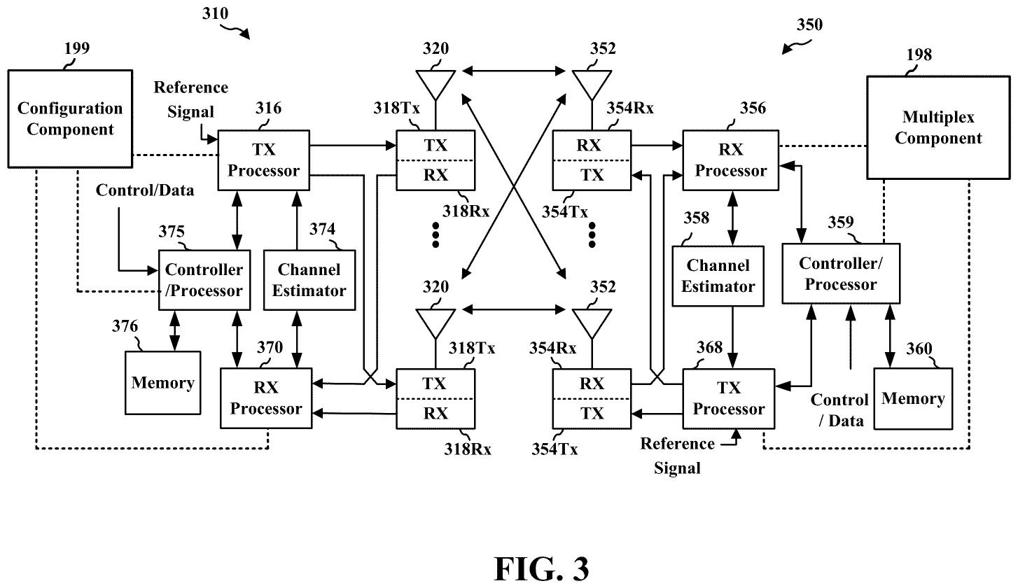

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multiplex component 198 of FIG. 1.

At least one of the TX processor 316, the RX processor 370, and the controller/processor 375 may be configured to perform aspects in connection with the configuration component 199 of FIG. 1.

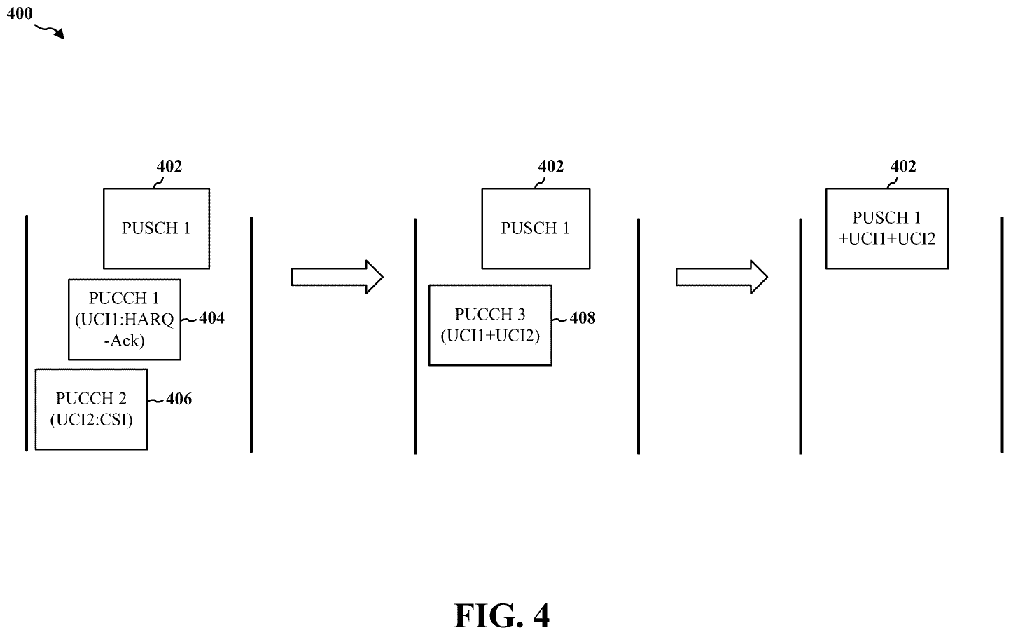

In wireless communications, certain multiplexing rules may be utilized to resolve a collision or time overlap between different uplink channels, such as in instances where PUSCH and PUCCH collide or when PUCCH and another PUCCH collide. Collisions between PUCCH and another PUCCH may be due to carrying different data or payloads, such as, for example, a collision between PUCCH for HARQ-ACK and PUCCH for scheduling request (SR), a collision between PUCCH for HARQ-ACK and PUCCH for channel state information (CSI), a collision between PUCCH for SR and PUCCH for CSI, or a collision between PUCCH for HARQ-ACK and PUCCH for CSI and PUCCH for SR. In these instances, under an assumption of joint timelines, multiple UCIs may be multiplexed on a PUCCH or on a PUSCH, as shown for example in diagram 400 of FIG. 4. In some instances, when one of the colliding channels is a PUSCH, the UCI may be multiplexed on the PUSCH. For example, the diagram 400 of FIG. 4 includes a PUSCH1 402, a PUCCH1 404 comprising a first UCI for HARQ-ACK, and a PUCCH2 406 comprising a second UCI for CSI. The PUSCH1 402, the PUCCH1 404, and the PUCCH2 406 may be overlapping or partially overlapping in time. The PUCCH1 404 and the PUCCH2 406 may be multiplexed to form PUCCH3 408 comprising the first UCI from PUCCH1 404 and the second UCI from the PUCCH2 406. The PUCCH3 408 and PUSCH1 402 may also be overlapping or partially overlapping. The PUCCH3 408 and PUSCH1 402 may be multiplexed to form PUSCH1 402 comprising the first UCI for PUCCH1 404 and the second UCI of PUCCH2 406. A general rule for multiplexing may include CSI multiplexing on PUCCH for instances where multiple CSI reports are in the slot, then HARQ-ACK/SR/CSI multiplexing on PUCCH when they overlap in the time domain, and UCI multiplexing with PUSCH when they overlap in the time domain.

In some instances, such as when a UCI overlaps with multiple PUSCHs in one or more uplink component carriers, if one of the PUSCHs has AP-CSI, then the UE selects the PUSCH with AP-CSI to multiplex the UCI. The UE does not expect more than one PUSCH with AP-CSI to overlap with the UCI. A UE does not expect a PUCCH resource that results from multiplexing overlapped PUCCH resources, if applicable, to overlap with more than one PUSCHs if each of the more than one PUSCHs includes aperiodic CSI reports. If a UE multiplexes aperiodic CSI in a PUSCH and the UE would multiplex UCI that includes HARQ-ACK information in a PUCCH that overlaps with the PUSCH and the timing conditions for overlapping PUCCHs and PUSCHs are fulfilled, the UE multiplexes only the HARQ-ACK information in the PUSCH and does not transmit the PUCCH. In some instances, dynamic grant PUSCHs (DG-PUSCHs) are considered or have priority over configured grant PUSCHs (CG-PUSCHs). The UE determines the PUSCH for UCI multiplexing if the candidate PUSCHs that include first PUSCHs that are scheduled by DCI formats and second PUSCHs configured by respective ConfiguredGrantConfig or semiPersistentOnPUSCH, and the UE would multiplex UCI in one of the candidate PUSCHs, and the candidate PUSCHs fulfil the conditions for UCI multiplexing, the UE multiplexes the UCI in a PUSCH from the first PUSCHs. In some instances, The PUSCH on a smallest component carrier index among the multiple PUSCHs may be considered for multiplexing. The UE multiplexes the UCI in a PUSCH of the serving cell with the smallest ServCellIndex. In some instances, the PUSCH that starts earliest in time may be considered for multiplexing if multiple PUSCHs are present in the component carrier having the smallest index. The UE multiplexes the UCI in the earliest PUSCH that the UE transmits in the slot. However, PUSCHs may not overlap in the time domain within the same component carrier, such as for instances where that more than one PUSCH is in a CC and is transmitted in a time division multiplex manner.

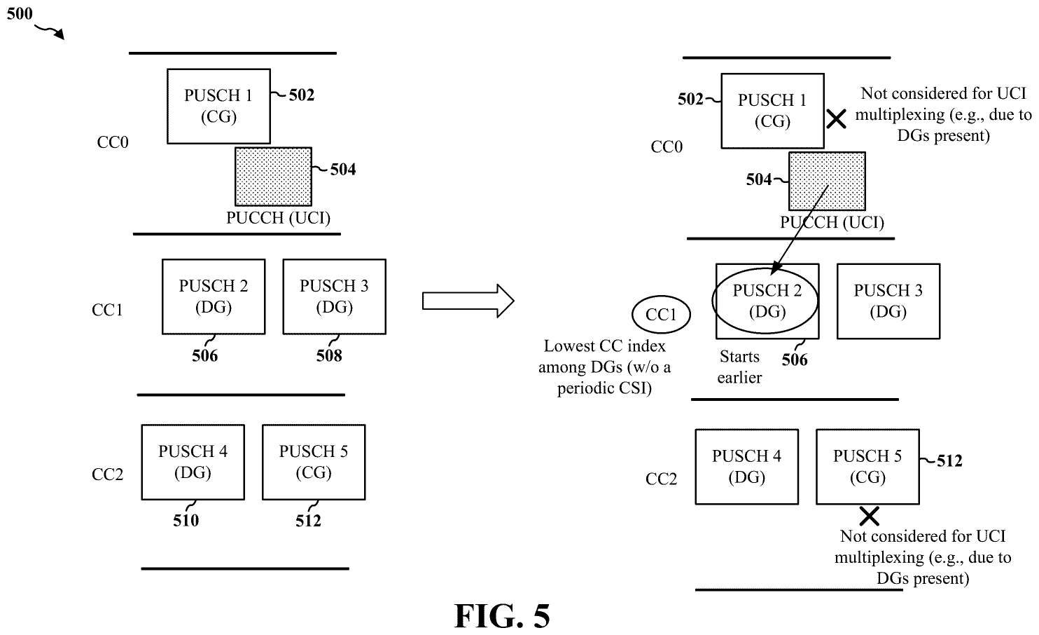

With reference to FIG. 5, diagram 500 provides an example of PUSCH candidates that may be considered for multiplexing. The diagram 500 includes a first component carrier CC0, a second component carrier CC1, and a third component carrier CC2. A PUSCH1 502 comprising a configured grant and a PUCCH 504 comprising a UCI are within CC0. A PUSCH2 506 comprising a dynamic grant and a PUSCH3 508 comprising a dynamic grant are within CC1. A PUSCH4 510 comprising a dynamic grant and a PUSCH5 512 comprising a configured grant are within CC2. Based on the above rules, the PUSCH1 502 is not considered for UCI multiplexing due in part to the presence of dynamic grants (e.g., PUSCH2 506, PUSCH3 508, PUSCH4 510). In addition, PUSCH5 512 is not considered for UCI multiplexing, also, due in part to the presence of dynamic grants (e.g., PUSCH2 506, PUSCH3 508, PUSCH4 510). The UE may select PUSCH2 506 for multiplexing the UCI due to the second component carrier CC1 having the lowest index among the presence of dynamic grants, without comprising aperiodic CSI, and due to the PUSCH2 506 starting earlier in time.

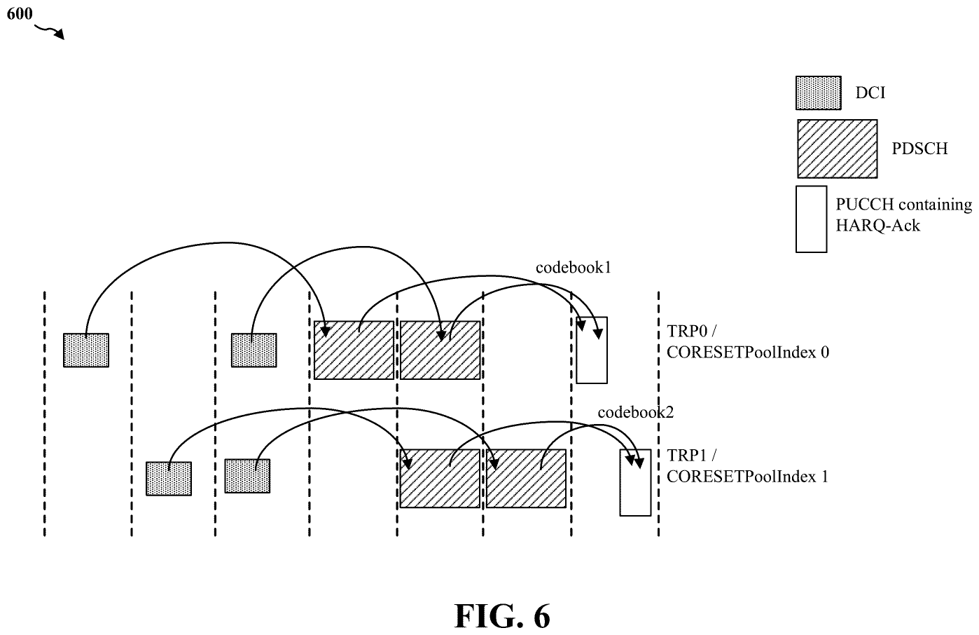

For instances of HARQ-ACK feedback for multi-DCI based multi-TRP (e.g., HARQ-ACK for PDSCH), either joint feedback or separate feedback may be configured. Joint ACK/NACK feedback, carried on the same PUCCH resource, may be utilized for ideal backhaul instances, such that data for different TRPs may be provided to one TRP and relayed to the other TRP. Separate ACK/NACK feedback, carried on the same PUCCH resource, may be utilized in both ideal and non-ideal backhaul instances, but may be mainly utilized in non-ideal backhaul instances. For example, HARQ-ACK reporting procedures are separately done for CORESET Pool Index 0 and 1. PUCCH resources that contain HARQ-ACK for different CORESET Pool Index values may be in the same slot but may not overlap, and should be time division multiplexed, as shown for example in diagram 600 of FIG. 6.

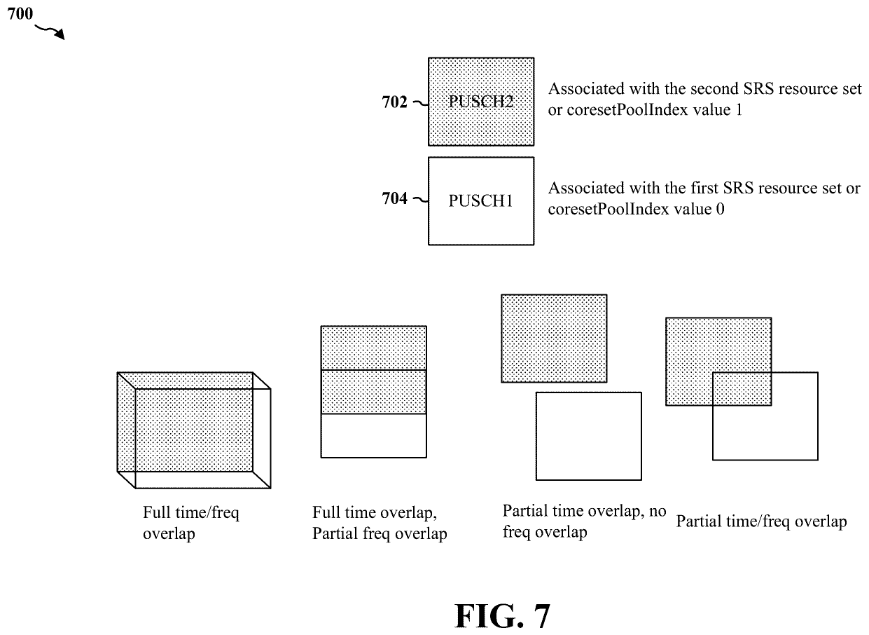

In instances where PUSCHs with multi-DCI overlap in the time domain, may or may not overlap in the frequency domain, may be enabled by multi-DCI based mTRP framework, where the two PUSCHs are associated with different CORESET Pool Index values. For example, a first PUSCH 704 may be associated with coresetPoolIndex value 0 and may be associated with a first SRS resource set, and may be transmitted using a first beam, TCI state, power control parameters, or precoder, as shown in diagram 700 of FIG. 7. A second PUSCH 702 may be associated with CORESET Pool Index value 1 and may be associated with a second SRS resource set and may be transmitted using a second beam, TCI state, power control parameters, or precoder.

The determination of which PUSCH to select for UCI multiplexing in instances where multiple PUSCHs are overlapping with the UCI in the time domain on one or more component carriers may impact the manner in which PUSCH is selected for multiplexing with UCI due in part to multiple PUSCHs in the same component carrier. In some instances, a configuration may be arranged to account for the group (e.g., CORESET Pool Index) of the UCI and the PUSCHs, or may be arranged to perform a selection of one of the PUSCHs to break a tie in the event that a unique PUSCH is not determined. However, there may be other manners in which to select the PUSCH for UCI multiplexing.

Aspects presented herein provide a configuration for multiplexing UCI with overlapping PUSCH based on at least one of a UCI type, the mode of the feedback, or a configuration of a PUCCH-cell. At least one advantage of the disclosure is that such factors may allow for selection of a PUSCH to multiplex with UCI. In some aspects, the factors may determine whether the UCI is associated with a CORESET Pool Index or not, and may assist in determining whether it is acceptable to multiplex UCI on a PUSCH towards any TRP or to specific TRPs or not. For example, if a backhaul between two TRPs is ideal, the network configures joint ACK/NACK. Hence, feedback type may be used to determine which factor to utilize to select the PUSCH for multiplexing with UCI. As another example, if UCI is a periodic or semi-persistent CSI on PUCCH (e.g., no dynamic HARQ-ACK included in the UCI), a TRP may be made aware of such semi-static PUCCH resources even in case of non-ideal backhaul.

In some instances, a UE may be provided with a CORESET Pool Index value of 0 for first CORESETs on active downlink bandwidth parts of component carriers, or may not be provided with a CORSET Pool Index value. The UE may be provided with a CORESET Pool Index value of 1 for second CORESETs on an active downlink bandwidth parts of the serving cells. This may ensure that multi-DCI based operation is configured, and that two groups of CORESETs are configured across one or more component carriers. In some instances, if the UE is configured with two SRS resource sets for codebook or non-codebook based PUSCH in at least one component carrier, or is configured with an RRC configuration that enables time domain overlapping PUSCHs in at least one component carrier. This may ensure that at least one component carrier is enabled with time domain overlapping PUSCHs with multi-DCI. In some instances, at least two of the PUSCHs that overlap with the UCI are also overlapping with each other, and are in the same component carrier and are associated with different CORESET Pool Index values.

In instances where UCI is associated with a CORESET Pool Index value, the UE may only consider the PUSCHs, from among multiple overlapping PUSCHs with the UCI, that are associated with the same CORESET Pool Index value as the one associated with the UCI. For example, in some aspects, the CORESET Pool Index may have a highest weight or priority, while in some aspects, the CORESET Pool Index may have a reduced weight or priority. For example, the CORESET Pool Index may be considered first, followed by dynamic grant or configured grant, then the lowest component carrier index, and then by the earliest start time in the same component carrier. In some aspects, such as when the CORESET Pool Index has a reduced weight or priority, the dynamic grant or configured grant may be considered first, then the CORESET Pool Index, then the lowest component carrier index, and then by the earliest start time in the same component carrier. In some aspects, the dynamic grant or configured grant may be considered first, followed by the lowest component carrier index, then the CORESET Pool Index, and then by the earliest start time in the same component carrier. It would be desirable to not end up multiplexing the UCI associated with a CORESET Pool Index value on a PUSCH associated with a different CORESET Pool Index value due to non-ideal backhaul between TRPs.

In instances where UCI is not associated with a CORESET Pool Index value, and if two dynamic grant PUSCHs, without AP-CSI, in the lowest component carrier index start at the same time, then the UE may select the PUSCH associated with a fixed CORESET Pool Index value (e.g., CORESETPoolIndex value 0) among the two PUSCHs with the same start time in the same component carrier. This may correspond to the UE considering dynamic grant over configured grant first, then the lowest component carrier index, then the earliest start time in the same component carrier, and then select the PUSCH associated with a CORESET Pool Index value 0. It would be desirable to multiplex the UCI on PUSCH associated with either CORESET Pool Index values due to ideal backhaul between TRPs or UCI being semi-static, but also include a tie-breaking mechanism in the event that a unique PUSCH is not determined.

In some aspects, the type or content of the UCI plays a role in the selection of the PUSCH for UCI multiplexing when multiple PUSCHs overlap with the UCI in a time domain on one or more CCs. If the UCI includes HARQ-ACK associated with both CORESET Pool Index values, then the UE may select the PUSCH associated with a fixed CORESET Pool Index value (e.g., CORESET Pool Index value 0) among the two PUSCHs with the same start time in the same component carrier. If the UCI type does not include HARQ-ACK, and only includes CSI (e.g., periodic or semi-persistent CSI on PUCCH), then the UE may select the PUSCH associated with a fixed CORESET Pool Index value (e.g., CORESET Pool Index value 0) among the two PUSCHs with the same start time in the same component carrier. If the UCI includes HARQ-ACK associated with only one CORESET Pool Index value, then the UE only considers the PUSCHs, among multiple overlapping PUSCHs with the UCI, that are associated with the same CORESET Pool Index value as the one associated with the UCI.

In some aspects, the feedback type mode (e.g., ackNackFeedbackMode) may play a role in the selection of the PUSCH for UCI multiplexing when multiple PUSCHs overlap with the UCI in a time domain on one or more CCs. If the feedback type mode is configured as joint, then the UE may select the PUSCH associated with a fixed CORESET Pool Index value (e.g., CORESET Pool Index value 0) among the two PUSCHs with the same start time in the same component carrier. If the feedback type mode is configured as separate, then the UE only considers the PUSCHs, among multiple overlapping PUSCHs with the UCI, that are associated with the same CORESET Pool Index value as the one associated with the UCI.

In some aspects, such as, if the feedback type mode is not configured, the UE may follow the behavior for instances where the feedback type mode is joint, then the UE may select the PUSCH associated with a fixed CORESET Pool Index value (e.g., CORESET Pool Index value 0) among the two PUSCHs with the same start time in the same component carrier. In some aspects, such as if the feedback type mode is not configured, the UE may follow the behavior for instances where the feedback type mode is separate, then the UE only considers the PUSCHs, among multiple overlapping PUSCHs with the UCI, that are associated with the same CORESET Pool Index value as the one associated with the UCI. In some aspects, if the feedback type mode is not configured, the type or content of the UCI plays a role in the selection of the PUSCH for UCI multiplexing when multiple PUSCHs overlap with the UCI in a time domain on one or more CCs. In some aspects, depending on scheduling, a HARQ-ACK may be associated with only one CORESET Pool Index value or may be associated with both CORESET Pool Index values. In such instances, the type or content of the UCI plays a role in the selection of the PUSCH for UCI multiplexing when multiple PUSCHs overlap with the UCI in a time domain on one or more CCs.

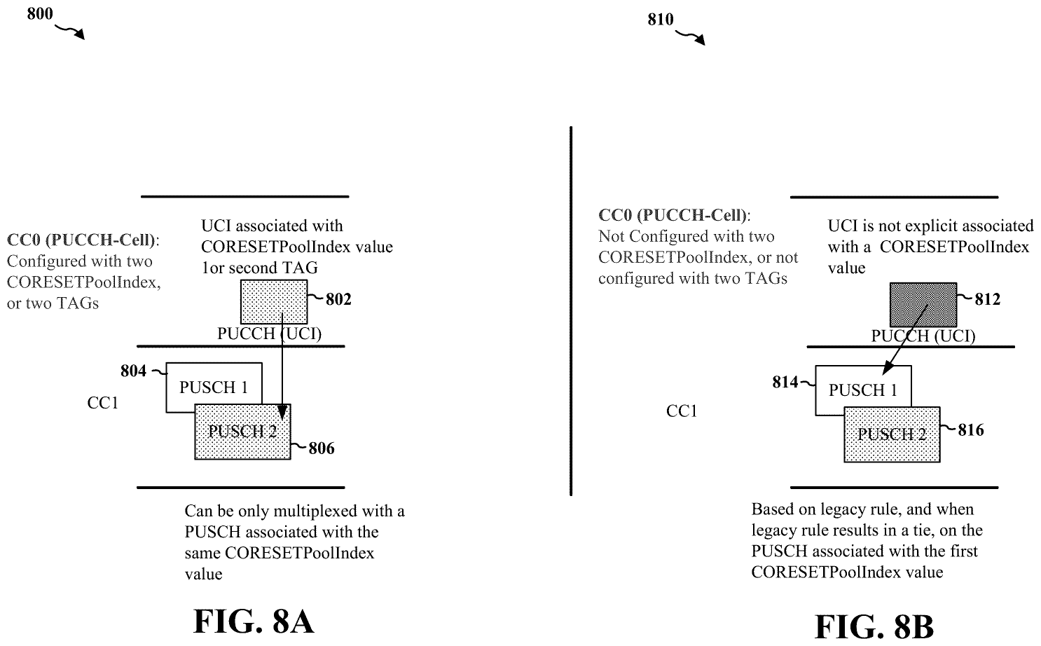

In some aspects, the configuration of the component carrier associated with the UCI (e.g., PUCCH-Cell) may play a role in the selection of the PUSCH for UCI multiplexing when multiple PUSCHs overlap with the UCI in a time domain on one or more component carriers. If the PUCCH-cell is configured with two CORESET Pool Index values, or two timing advance groups (TAGs), or two groups of PUCCH resources for applying two indicated TCI states, then the UE only considers the PUSCHs, among multiple overlapping PUSCHs with the UCI, that are associated with the same CORESET Pool Index value as the one associated with the UCI, otherwise, the UE may select the PUSCH associated with a fixed CORESET Pool Index value (e.g., CORESET Pool Index value 0) among the two PUSCHs with the same start time in the same component carrier. With reference to diagram 800 of FIG. 8A, a first component carrier CC0 configured with two CORESET Pool Index or with two TAGs. The first component carrier CC0 comprises a PUCCH 802 comprising UCI associated with CORESET Pool Index value 1 or a second TAG. Diagram 800 further includes a second component carrier CC1 comprising a PUSCH1 804 and a PUSCH2 806. The PUCCH 802 and the PUSCH2 806 are associated with the same CORESET Pool Index value, such that PUCCH 802 may be multiplexed with the PUSCH2 806 because both are associated with the same CORESET Pool Index value. With reference to diagram 810 of FIG. 8B, a first component carrier CC0 is not configured with two CORESET Pool Index and/or not configured with two TAGs. The first component carrier CC0 of FIG. 8B comprises a PUCCH 812 comprising a UCI not explicitly associated with a CORESET Pool Index value. A second component carrier CC1 comprises a PUSCH1 814 and a PUSCH2 816. The UE may select PUSCH1 814 to multiplex with the PUCCH 812 based on the PUSCH1 814 being associated with a first CORESET Pool Index value.

In some aspects, such as for UCI multiplexing when multiple PUSCHs overlap with the UCI in a time domain on one or more component carriers, and at least one of the PUSCHs comprises AP-CSI, if the UCI and the PUSCH with the AP-CSI are associated with the same CORESET Pool Index value, then the UE multiplexes the UCI on that PUSCH. If the UCI and the PUSCH with the AP-CSI are not associated with the same CORESET Pool Index value, then the UE may multiplex the UCI on another PUSCH among the multiple PUSCHs that are associated with the same CORESET Pool Index value as the one associated with the UCI. If the UCI and the PUSCH with the AP-CSI are not associated with the same CORESET Pool Index value, then the UE may drop the UCI. If the UCI and the PUSCH with the AP-CSI are not associated with the same CORESET Pool Index value, then the UE does not expect UCI to overlap with a PUSCH that includes AP-CSI if the UCI and the PUSCH are not associated with the same CORESET Pool Index value. In some aspects, if one of the multiple PUSCHs comprises AP-CSI, the UE multiplexes the UCI on the PUSCH with AP-CSI irrespective of the association of the PUSCH with CORESET Pool Index value.

In some aspects, such as if two of the multiple PUSCHs include AP-CSI, such that the two PUSCHs are associated with different CORESET Pool Index values, the UE does not expect more than one PUSCH with AP-CSI to overlap with the UCI may be relaxed but is maintained per CORESET Pool Index value. For example, the PUSCH that is associated with the same CORESET Pool Index as the UCI is selected for multiplexing with the UCI. In some aspects, the PUSCH associated with a fixed CORESET Pool Index value (e.g., value 0) is selected for multiplexing with the UCI. In some aspects, UCI includes at least HARQ-ACK, if UCI only includes periodic or semi-periodic CSI, the UCI is completely dropped since AP-CSI on PUSCH has a higher priority. If UCI includes HARQ-ACK and CSI, only the HARQ-ACK part is multiplexed on a PUSCH.

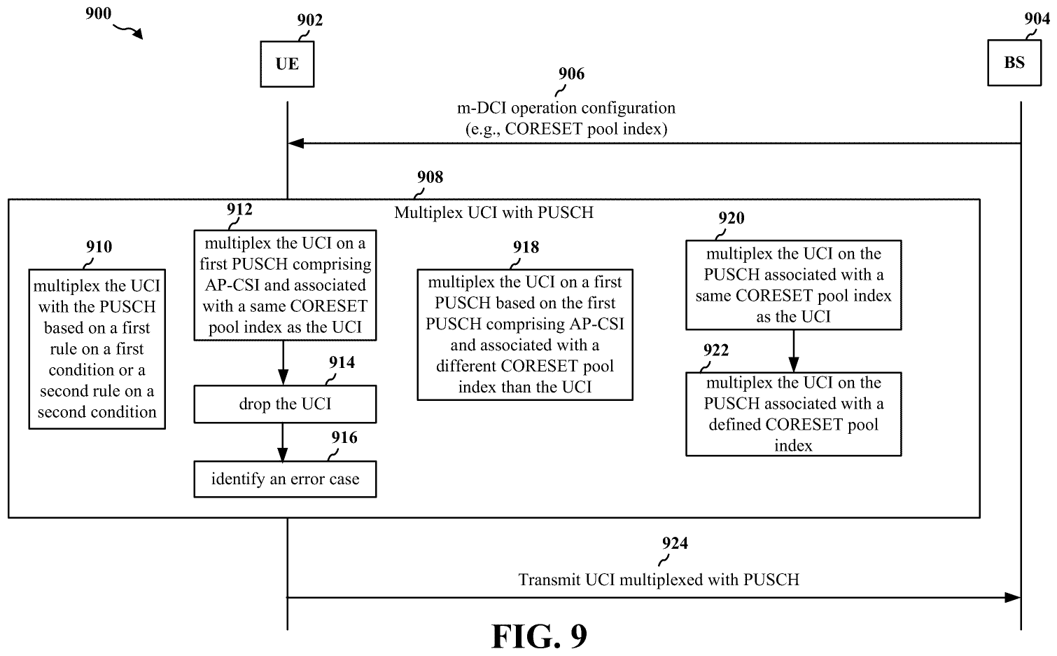

FIG. 9 is a call flow diagram 900 of signaling between a UE 902 and a base station 904. The base station 904 may be configured to provide at least one cell. The UE 902 may be configured to communicate with the base station 904. For example, in the context of FIG. 1, the base station 904 may correspond to base station 102 and the UE 902 may correspond to at least UE 104. In another example, in the context of FIG. 3, the base station 904 may correspond to base station 310 and the UE 902 may correspond to UE 350.

At 906, the base station 904 may provide a configuration for multiple DCI operation for a UE, as shown in connection with any of FIGS. 5-8B. The base station 904 may provide the configuration for the multiple DCI operation to the UE 902. The UE 902 may receive the configuration for multiple DCI operation. The configuration for multiple DCI operation for the UE may include associations with CORESETs configured for the UE. The associations may include a CORESET pool index 0 or an absence of a CORESET pool index, and a CORESET pool index 1.

At 908, the UE may multiplex a UCI with a PUSCH. For example, at 910, the UE may multiplex the UCI with the PUSCH based on a first rule on a first condition or a second rule on a second condition, as shown in connection with any of FIGS. 5-8B. For example, the UE may use the first rule to multiplex the UCI with the PUSCH based on the first condition. In another example, the UE may use the second rule to multiplex the UCI with the PUSCH based on the second condition. In some aspects, the UE may multiplex the UCI with the PUSCH from the multiple overlapping PUSCHs based on the type of the UCI or the content of the UCI. In such aspects, the UE may multiplex the UCI with the PUSCH based on a first rule on a first condition that the content of the UCI includes a hybrid automatic repeat request acknowledgement (HARQ-ACK) associated with multiple CORESET pool indexes of multiple groups or UCI does not include the HARQ-ACK. In some aspects, the UE multiplexes the UCI with the PUSCH from the multiple overlapping PUSCHs based on the feedback mode. The UE may multiplex the UCI with the PUSCH based on a first rule on a first condition that the UE is configured with a joint ACK/NACK feedback mode. In some aspects, such as in the absence of an ACK NACK feedback mode, the UE may multiplex the UCI with the PUSCH based on a first rule applied for a joint ACK NACK feedback mode. In some aspects, the UCI is multiplexed with the PUSCH from the multiple overlapping PUSCHs based on the carrier configuration for a component carrier (CC) associated with the UCI. For example, the UE may multiplex the UCI with the PUSCH based on a first rule on a first condition that the CC associated with the UCI is configured with a single CORESET pool index, a single timing advance group (TAG), or a physical uplink control channel (PUCCH) resource for a single transmission configuration indicator (TCI) state. In some aspects, the UE may multiplex the UCI with the PUSCH from the multiple overlapping PUSCHs based on the type of the UCI or the content of the UCI. In such aspects, the UE may multiplex the UCI with the PUSCH based on a second rule on a second condition that the content of the UCI includes the HARQ-ACK associated with a single CORESET pool index. In some aspects, the UCI is multiplexed with the PUSCH from the multiple overlapping PUSCHs based on the feedback mode. For example, in such aspects, the UE may multiplex the UCI with the PUSCH based on a second rule on a second condition that the UE is configured with a separate ACK NACK feedback mode. In some aspects, such as in the absence of an ACK NACK feedback mode, the UE may multiplex the UCI with the PUSCH based on a second rule applied for a separate ACK NACK feedback mode, or a rule based on the type of the UCI or the content of the UCI. In some aspects, the UCI is multiplexed with the PUSCH from the multiple overlapping PUSCHs based on the carrier configuration for a component carrier (CC) associated with the UCI. In such aspects, for example, the UE may multiplex the UCI with the PUSCH based on a second rule on a second condition that the CC associated with the UCI is configured with multiple CORESET pool indexes, multiple TAGs, or multiple PUCCH resources for multiple TCI states.

In some aspects, for example at 912, the UE may multiplex the UCI on the first PUSCH further based on the first PUSCH comprising aperiodic channel state information (AP-CSI) and being associated with a same CORESET pool index as the UCI, as shown in connection with any of FIGS. 5-8B. In some aspects, a first PUSCH of the multiple overlapping PUSCHs includes AP-CSI. At 914, the UE may drop the UCI. The UE may drop the UCI based on the first PUSCH being associated with a different CORESET pool index than the UCI. At 916, the UE may identify an error case. The UE may identify the error case based on an overlap in the time domain of the UCI with the first PUSCH having a different CORESET pool index than the UCI.

In some aspects, for example at 918, the UE may multiplex the UCI on the first PUSCH further based on the first PUSCH comprising the AP-CSI and being associated with a different CORESET pool index than the UCI, as shown in connection with any of FIGS. 5-8B. In some aspects, a first PUSCH of the multiple overlapping PUSCHs includes AP-CSI.

In some aspects, for example at 920, the UE may multiplex the UCI on the PUSCH associated with a same CORESET pool index as the UCI, as shown in connection with any of FIGS. 5-8B. In some aspects, at least two of the multiple overlapping PUSCHs include AP-CSI. At 922, the UE may multiplex the UCI on the PUSCH associated with a defined CORESET pool index, as shown in connection with any of FIGS. 5-8B.

At 924, the UE may transmit UCI multiplexed with a physical uplink shared channel (PUSCH) from multiple overlapping PUSCHs that overlap in a time domain on one or more carriers and overlap in the time domain with the UCI, as shown in connection with any of FIGS. 5-8B. The multiplexing may be based on at least one of a type of the UCI, content of the UCI, a feedback mode or a carrier configuration.

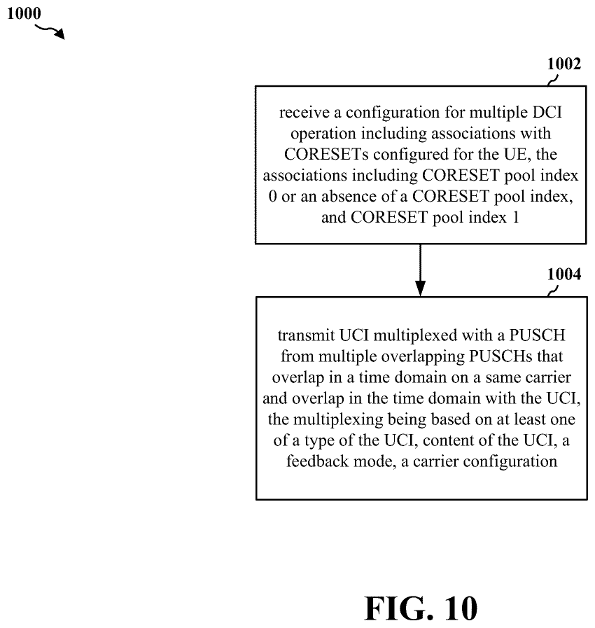

FIG. 10 is a flowchart 1000 of a method of wireless communication. The method may be performed by a UE (e.g., the UE 104; the apparatus 1204). One or more of the illustrated operations may be omitted, transposed, or contemporaneous. The method may configure a multiplexing rule for the UE based on a UCI type/payload, on a configuration of a mode of feedback (e.g., joint or separate), or on a configuration of a PUCCH cell.

At 1002, the UE may receive a configuration for multiple DCI operation including associations with CORESETs configured for the UE, as shown in connection with any of FIGS. 5-8B. For example, 1002 may be performed by multiplex component 198 of apparatus 1204. The associations may include a CORESET pool index 0 or an absence of a CORESET pool index, and a CORESET pool index 1.

At 1004, the UE may transmit UCI multiplexed with a PUSCH from multiple overlapping PUSCHs that overlap in a time domain on a same carrier and overlap in the time domain with the UCI, as shown in connection with any of FIGS. 5-8B. For example, 1004 may be performed by multiplex component 198 of apparatus 1204. The multiplexing may be based on at least one of a type of the UCI, content of the UCI, a feedback mode or a carrier configuration.

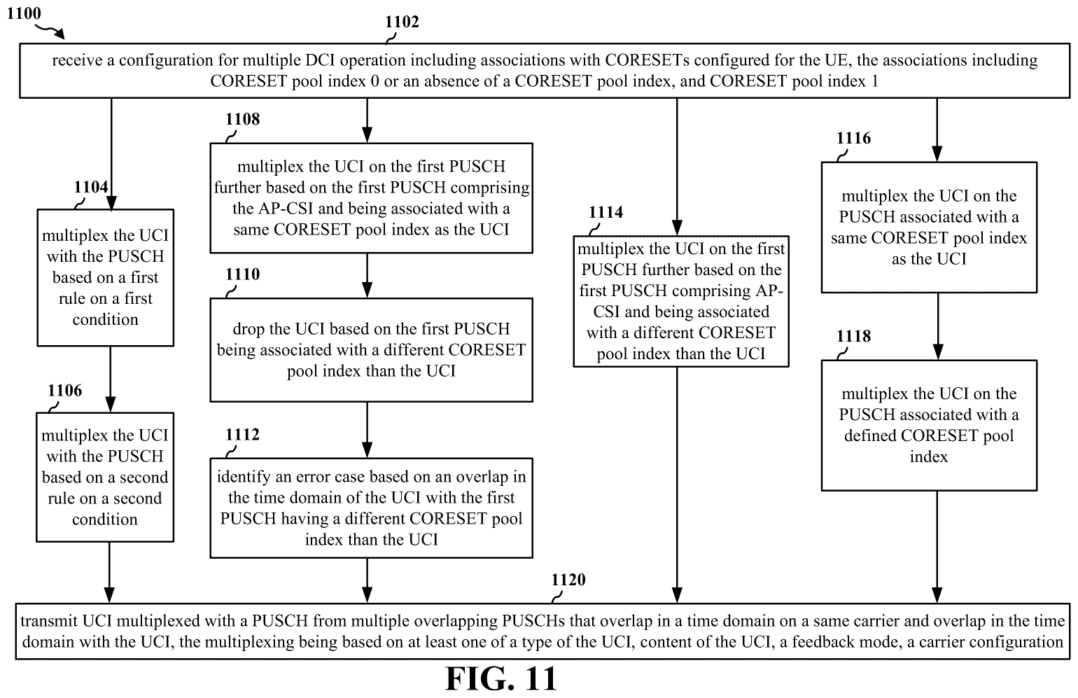

FIG. 11 is a flowchart 1100 of a method of wireless communication. The method may be performed by a UE (e.g., the UE 104; the apparatus 1204). One or more of the illustrated operations may be omitted, transposed, or contemporaneous. The method may configure a multiplexing rule for the UE based on a UCI type/payload, on a configuration of a mode of feedback (e.g., joint or separate), or on a configuration of a PUCCH cell.

At 1102, the UE may receive a configuration for multiple DCI operation including associations with CORESETs configured for the UE, as shown in connection with any of FIGS. 5-8B. For example, 1102 may be performed by multiplex component 198 of apparatus 1204. The associations may include a CORESET pool index 0 or an absence of a CORESET pool index, and a CORESET pool index 1.

At 1104, the UE may multiplex the UCI with the PUSCH based on a first rule on a first condition, as shown in connection with any of FIGS. 5-8B. For example, 1104 may be performed by multiplex component 198 of apparatus 1204. In some aspects, the UE may multiplex the UCI with the PUSCH from the multiple overlapping PUSCHs based on the type of the UCI or the content of the UCI. In such aspects, the UE may multiplex the UCI with the PUSCH based on a first rule on a first condition that the content of the UCI includes a hybrid automatic repeat request acknowledgement (HARQ-ACK) associated with multiple CORESET pool indexes of multiple groups or UCI does not include the HARQ-ACK. In some aspects, the UE multiplexes the UCI with the PUSCH from the multiple overlapping PUSCHs based on the feedback mode. The UE may multiplex the UCI with the PUSCH based on a first rule on a first condition that the UE is configured with a joint ACK NACK feedback mode. In some aspects, such as in an absence of a configured ACK NACK feedback mode, the UE may multiplex the UCI with the PUSCH based on a first rule applied for a joint ACK NACK feedback mode. In some aspects, the UCI is multiplexed with the PUSCH from the multiple overlapping PUSCHs based on the carrier configuration for a component carrier (CC) associated with the UCI. For example, the UE may multiplex the UCI with the PUSCH based on a first rule on a first condition that the CC associated with the UCI is configured with a single CORESET pool index, a single timing advance group (TAG), or a physical uplink control channel (PUCCH) resource for a single transmission configuration indicator (TCI) state.

At 1106, the UE may multiplex the UCI with the PUSCH based on a second rule on a second condition, as shown in connection with any of FIGS. 5-8B. For example, 1106 may be performed by multiplex component 198 of apparatus 1204. In some aspects, the UE may multiplex the UCI with the PUSCH from the multiple overlapping PUSCHs based on the type of the UCI or the content of the UCI. In such aspects, the UE may multiplex the UCI with the PUSCH based on a second rule on a second condition that the content of the UCI includes the HARQ-ACK associated with a single CORESET pool index. In some aspects, the UCI is multiplexed with the PUSCH from the multiple overlapping PUSCHs based on the feedback mode. For example, in such aspects, the UE may multiplex the UCI with the PUSCH based on a second rule on a second condition that the UE is configured with a separate ACK NACK feedback mode. In some aspects, such as in the absence of a configured ACK NACK feedback mode, the UE may multiplex the UCI with the PUSCH based on a second rule applied for a separate ACK NACK feedback mode, or a rule based on the type of the UCI or the content of the UCI. In some aspects, the UCI is multiplexed with the PUSCH from the multiple overlapping PUSCHs based on the carrier configuration for a component carrier (CC) associated with the UCI. In such aspects, for example, the UE may multiplex the UCI with the PUSCH based on a second rule on a second condition that the CC associated with the UCI is configured with multiple CORESET pool indexes, multiple TAGs, or multiple PUCCH resources for multiple TCI states.

At 1108, the UE may multiplex the UCI on the first PUSCH further based on the first PUSCH comprising AP-CSI and being associated with a same CORESET pool index as the UCI. For example, 1108 may be performed by multiplex component 198 of apparatus 1204. In some aspects, a first PUSCH of the multiple overlapping PUSCHs includes AP-CSI.

At 1110, the UE may drop the UCI. For example, 1110 may be performed by multiplex component 198 of apparatus 1204. The UE may drop the UCI based on the first PUSCH being associated with a different CORESET pool index than the UCI.

At 1112, the UE may identify an error case. For example, 1112 may be performed by multiplex component 198 of apparatus 1204. The UE may identify the error case based on an overlap in the time domain of the UCI with the first PUSCH having a different CORESET pool index than the UCI.

At 1114, the UE may multiplex the UCI on the first PUSCH further based on the first PUSCH comprising the AP-CSI and being associated with a different CORESET pool index than the UCI, as shown in connection with any of FIGS. 5-8B. For example, 1114 may be performed by multiplex component 198 of apparatus 1204. In some aspects, a first PUSCH of the multiple overlapping PUSCHs includes AP-CSI.

At 1116, the UE may multiplex the UCI on the PUSCH associated with a same CORESET pool index as the UCI, as shown in connection with any of FIGS. 5-8B. For example, 1116 may be performed by multiplex component 198 of apparatus 1204. In some aspects, at least two of the multiple overlapping PUSCHs include AP-CSI.

At 1118, the UE may multiplex the UCI on the PUSCH associated with a defined CORESET pool index, as shown in connection with any of FIGS. 5-8B. For example, 1116 may be performed by multiplex component 198 of apparatus 1204.

At 1120, the UE may transmit UCI multiplexed with a PUSCH from multiple overlapping PUSCHs that overlap in a time domain on a same carrier and overlap in the time domain with the UCI, as shown in connection with any of FIGS. 5-8B. For example, 1120 may be performed by multiplex component 198 of apparatus 1204. The multiplexing may be based on at least one of a type of the UCI, content of the UCI, a feedback mode or a carrier configuration.

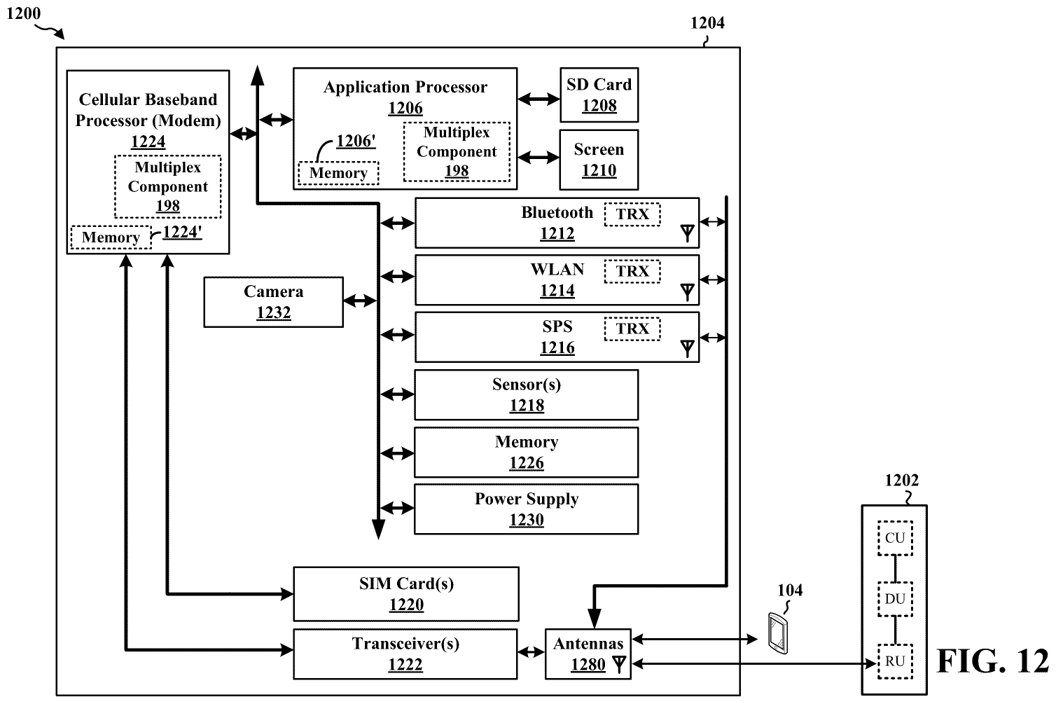

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive a configuration for multiple DCI operation including associations with CORESETs configured for the UE, the associations including CORESET pool index 0 or an absence of a CORESET pool index, and CORESET pool index 1; and transmit UCI multiplexed with a PUSCH from multiple overlapping PUSCHs that overlap in a time domain on a same carrier and overlap in the time domain with the UCI, the multiplexing being based on at least one of a type of the UCI, content of the UCI, a feedback mode or a carrier configuration. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving a configuration for multiple DCI operation including associations with CORESETs configured for the UE, the associations including CORESET pool index 0 or an absence of a CORESET pool index, and CORESET pool index 1. The apparatus includes means for transmitting UCI multiplexed with a PUSCH from multiple overlapping PUSCHs that overlap in a time domain on a same carrier and overlap in the time domain with the UCI, the multiplexing being based on at least one of a type of the UCI, content of the UCI, a feedback mode or a carrier configuration. The apparatus further includes means for multiplexing the UCI with the PUSCH based on a first rule on a first condition that the content of the UCI includes a HARQ-ACK associated with multiple CORESET pool indexes of multiple groups or UCI does not include the HARQ-ACK. The apparatus further includes means for multiplexing the UCI with the PUSCH based on a second rule on a second condition that the content of the UCI includes the HARQ-ACK associated with a single CORESET pool index. The apparatus further includes means for multiplexing the UCI with the PUSCH based on a first rule on a first condition that the UE is configured with a joint ACK NACK feedback mode. The apparatus further includes means for multiplexing the UCI with the PUSCH based on a second rule on a second condition that the UE is configured with a separate ACK NACK feedback mode. The apparatus further includes means for multiplexing the UCI with the PUSCH based on a first rule on a first condition that the CC associated with the UCI is configured with a single CORESET pool index, a single TAG, or a PUCCH resource for a single TCI state. The apparatus further includes means for multiplexing the UCI with the PUSCH based on a second rule on a second condition that the CC associated with the UCI is configured with multiple CORESET pool indexes, multiple TAGs, or multiple PUCCH resources for multiple TCI states. The apparatus further includes means for multiplexing the UCI on the first PUSCH further based on the first PUSCH comprising the AP-CSI and being associated with a same CORESET pool index as the UCI. The apparatus further includes means for dropping the UCI based on the first PUSCH being associated with a different CORESET pool index than the UCI. The apparatus further includes means for identifying an error case based on an overlap in the time domain of the UCI with the first PUSCH having a different CORESET pool index than the UCI. The apparatus further includes means for multiplexing the UCI on the first PUSCH further based on the first PUSCH comprising the AP-CSI and being associated with a different CORESET pool index than the UCI. The apparatus further includes means for multiplexing the UCI on the PUSCH associated with a same CORESET pool index as the UCI. The apparatus further includes means for multiplexing the UCI on the PUSCH associated with a defined CORESET pool index. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

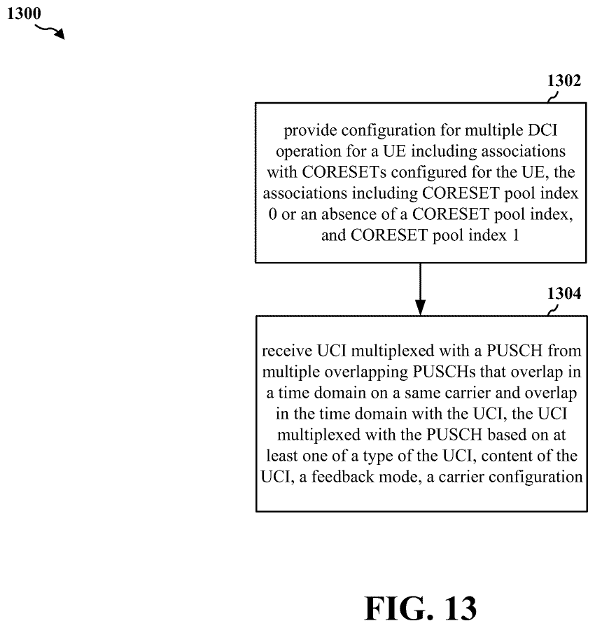

FIG. 13 is a flowchart 1300 of a method of wireless communication. The method may be performed by a base station (e.g., the base station 102; the network entity 1402). One or more of the illustrated operations may be omitted, transposed, or contemporaneous. The method may configure a multiplexing rule for the UE based on a UCI type/payload, on a configuration of a mode of feedback (e.g., joint or separate), or on a configuration of a PUCCH cell.

At 1302, the network entity may provide a configuration for multiple DCI operation for a UE, as shown in connection with any of FIGS. 5-8B. For example, 1302 may be performed by configuration component 199 of network entity 1402. The configuration for multiple DCI operation for the UE may include associations with CORESETs configured for the UE. The associations may include a CORESET pool index 0 or an absence of a CORESET pool index, and a CORESET pool index 1.

At 1304, the network entity may receive UCI multiplexed with a PUSCH from multiple overlapping PUSCHs that overlap in a time domain on a same carrier and overlap in the time domain with the UCI, as shown in connection with any of FIGS. 5-8B. For example, 1304 may be performed by configuration component 199 of network entity 1402. The UCI multiplexed with the PUSCH may be based on at least one of a type of the UCI, content of the UCI, a feedback mode or a carrier configuration. In some aspects, the UCI is multiplexed with the PUSCH from the multiple overlapping PUSCHs based on the type of the UCI or the content of the UCI. In such aspects, the UCI is multiplexed with the PUSCH based on a first rule on a first condition that the content of the UCI includes a hybrid automatic repeat request acknowledgement (HARQ-ACK) associated with multiple CORESET pool indexes of multiple groups or UCI does not include the HARQ-ACK. In some aspects, the UCI is multiplexed with the PUSCH based on a second rule on a second condition that the content of the UCI includes the HARQ-ACK associated with a single CORESET pool index.

In some aspects, the UCI is multiplexed with the PUSCH from the multiple overlapping PUSCHs based on the feedback mode. In some aspects, the UCI is multiplexed with the PUSCH based on a first rule on a first condition that the UE is configured with a joint acknowledgement (ACK) negative acknowledgement (NACK) feedback mode. In some aspects, the UCI is multiplexed with the PUSCH based on a second rule on a second condition that the UE is configured with a separate ACK NACK feedback mode. In instances where an ACK/NACK feedback mode is not configured, the UCI is multiplexed with the PUSCH based on one of a first rule applied for a joint ACK NACK feedback mode, a second rule applied for a separate ACK NACK feedback mode, or a rule based on the type of the UCI or the content of the UCI.

In some aspects, the UCI is multiplexed with the PUSCH from the multiple overlapping PUSCHs based on the carrier configuration for a component carrier (CC) associated with the UCI. In some aspects, the UCI is multiplexed with the PUSCH based on a first rule on a first condition that the CC associated with the UCI is configured with a single CORESET pool index, a single timing advance group (TAG), or a PUCCH resource for a single TCI state. In some aspects, the UCI is multiplexed with the PUSCH based on a second rule on a second condition that the CC associated with the UCI is configured with multiple CORESET pool indexes, multiple TAGs, or multiple PUCCH resources for multiple TCI states.

In some aspects, a first PUSCH of the multiple overlapping PUSCHs includes aperiodic channel state information (AP-CSI). The UCI is multiplexed on the first PUSCH based on the first PUSCH comprising the AP-CSI and being associated with a same CORESET pool index as the UCI. In some aspects, scheduling of the UCI to overlap in the time domain with the first PUSCH having a different CORESET pool index than the UCI may be avoided. In some aspects, a first PUSCH of the multiple overlapping PUSCHs includes AP-CSI. The UCI is multiplexed on the first PUSCH further based on the first PUSCH comprising the AP-CSI and being associated with a different CORESET pool index than the UCI. In some aspects, at least two of the multiple overlapping PUSCHs include AP-CSI. In such instances, the UCI is multiplexed on the PUSCH associated with a same CORESET pool index as the UCI or is multiplexed on the PUSCH associated with a defined CORESET pool index.

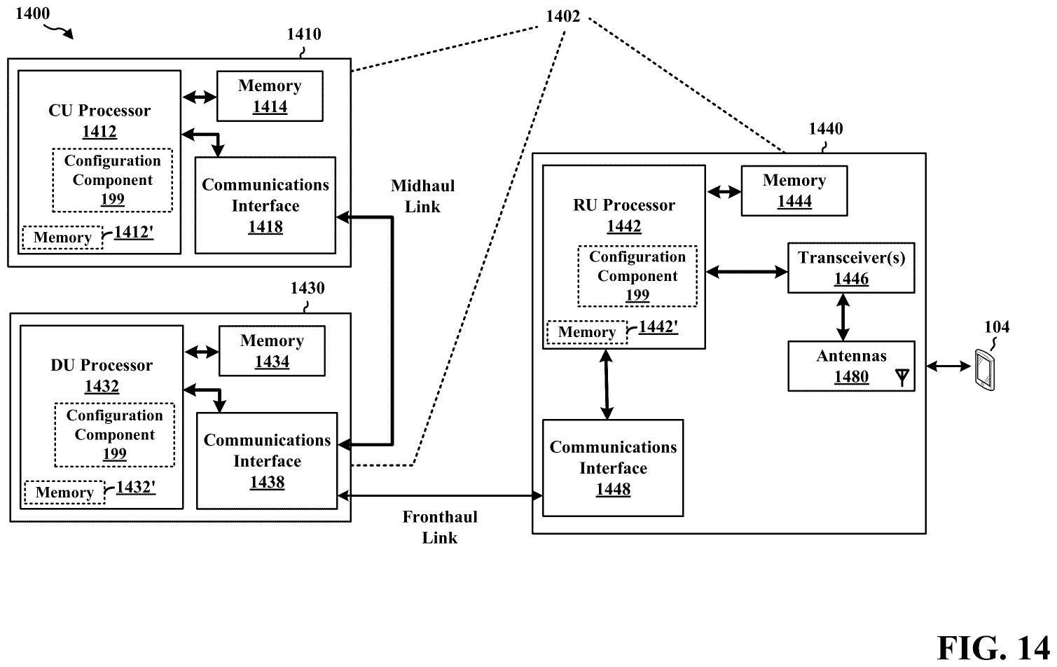

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide configuration for multiple DCI operation for a UE including associations with CORESETs configured for the UE, the associations including CORESET pool index 0 or an absence of a CORESET pool index, and CORESET pool index 1; and receive UCI multiplexed with a PUSCH from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for providing configuration for multiple DCI operation for a UE including associations with CORESETs configured for the UE, the associations including CORESET pool index 0 or an absence of a CORESET pool index, and CORESET pool index 1. The network entity includes means for receiving UCI multiplexed with a PUSCH from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising receiving a configuration for multiple DCI operation including associations with CORESETs configured for the UE, the associations including CORESET pool index 0 or an absence of a CORESET pool index, and CORESET pool index 1; and transmitting UCI multiplexed with a PUSCH from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

Aspect 2 is the method of aspect 1, further includes that the UCI is multiplexed with the PUSCH from the multiple overlapping PUSCHs based on the type of the UCI or the content of the UCI.

Aspect 3 is the method of any of aspects 1 and 2, further including multiplexing the UCI with the PUSCH based on a first rule on a first condition that the content of the UCI includes a HARQ-ACK associated with multiple CORESET pool indexes of multiple groups or UCI does not include the HARQ-ACK; or multiplexing the UCI with the PUSCH based on a second rule on a second condition that the content of the UCI includes the HARQ-ACK associated with a single CORESET pool index.

Aspect 4 is the method of any of aspects 1-3, further includes that the UCI is multiplexed with the PUSCH from the multiple overlapping PUSCHs based on the feedback mode.

Aspect 5 is the method of any of aspects 1-4, further including multiplexing the UCI with the PUSCH based on a first rule on a first condition that the UE is configured with a joint ACK NACK feedback mode; or multiplexing the UCI with the PUSCH based on a second rule on a second condition that the UE is configured with a separate ACK NACK feedback mode.

Aspect 6 is the method of any of aspects 1-5, further includes that in an absence of a configured acknowledgement (ACK) negative acknowledgement (NACK) feedback mode, the apparatus further comprising multiplexing the UCI with the PUSCH based on one of a first rule applied for a joint ACK NACK feedback mode, a second rule applied for a separate ACK NACK feedback mode, or a rule based on the type of the UCI or the content of the UCI.

Aspect 7 is the method of any of aspects 1-6, further includes that the UCI is multiplexed with the PUSCH from the multiple overlapping PUSCHs based on the carrier configuration for a CC associated with the UCI.

Aspect 8 is the method of any of aspects 1-7, further including multiplexing the UCI with the PUSCH based on a first rule on a first condition that the CC associated with the UCI is configured with a single CORESET pool index, a single TAG, or a PUCCH resource for a single TCI state; or multiplexing the UCI with the PUSCH based on a second rule on a second condition that the CC associated with the UCI is configured with multiple CORESET pool indexes, multiple TAGs, or multiple PUCCH resources for multiple TCI states.

Aspect 9 is the method of any of aspects 1-8, further includes that a first PUSCH of the multiple overlapping PUSCHs includes AP-CSI, further including multiplexing the UCI on the first PUSCH further based on the first PUSCH comprising the AP-CSI and being associated with a same CORESET pool index as the UCI; dropping the UCI based on the first PUSCH being associated with a different CORESET pool index than the UCI; or identifying an error case based on an overlap in the time domain of the UCI with the first PUSCH having the different CORESET pool index than the UCI.

Aspect 10 is the method of any of aspects 1-9, further includes that a first PUSCH of the multiple overlapping PUSCHs includes AP-CSI, further including multiplexing the UCI on the first PUSCH further based on the first PUSCH comprising the AP-CSI and being associated with a different CORESET pool index than the UCI.

Aspect 11 is the method of any of aspects 1-10, further includes that at least two of the multiple overlapping PUSCHs include AP-CSI, further including multiplexing the UCI on the PUSCH associated with a same CORESET pool index as the UCI; or multiplexing the UCI on the PUSCH associated with a defined CORESET pool index.

Aspect 12 is an apparatus for wireless communication at a UE including at least one processor coupled to a memory and at least one transceiver, the at least one processor configured to implement any of Aspects 1-11.

Aspect 13 is an apparatus for wireless communication at a UE including means for implementing any of Aspects 1-11.

Aspect 14 is a computer-readable medium storing computer executable code, where the code when executed by a processor causes the processor to implement any of Aspects 1-11.

Aspect 15 is a method of wireless communication at a network node comprising providing configuration for multiple DCI operation for a UE including associations with CORESETs configured for the UE, the associations including CORESET pool index 0 or an absence of a CORESET pool index, and CORESET pool index 1; and receiving UCI multiplexed with a PUSCH from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

Aspect 16 is the method of aspect 15, further includes that the UCI is multiplexed with the PUSCH from the multiple overlapping PUSCHs based on the type of the UCI or the content of the UCI.

Aspect 17 is the method of any of aspects 15 and 16, further includes that one of the UCI is multiplexed with the PUSCH based on a first rule on a first condition that the content of the UCI includes a HARQ-ACK associated with multiple CORESET pool indexes of multiple groups or UCI does not include the HARQ-ACK; or the UCI is multiplexed with the PUSCH based on a second rule on a second condition that the content of the UCI includes the HARQ-ACK associated with a single CORESET pool index.

Aspect 18 is the method of any of aspects 15-17, further includes that the UCI is multiplexed with the PUSCH from the multiple overlapping PUSCHs based on the feedback mode.

Aspect 19 is the method of any of aspects 15-18, further includes that one of the UCI is multiplexed with the PUSCH based on a first rule on a first condition that the UE is configured with a joint ACK NACK feedback mode; or the UCI is multiplexed with the PUSCH based on a second rule on a second condition that the UE is configured with a separate ACK NACK feedback mode.

Aspect 20 is the method of any of aspects 15-19, further includes that an ACK NACK feedback mode is not configured, and wherein the UCI is multiplexed with the PUSCH based on one of a first rule applied for a joint ACK NACK feedback mode, a second rule applied for a separate ACK NACK feedback mode, or a rule based on the type of the UCI or the content of the UCI.

Aspect 21 is the method of any of aspects 15-20, further includes that the UCI is multiplexed with the PUSCH from the multiple overlapping PUSCHs based on the carrier configuration for a CC associated with the UCI.

Aspect 22 is the method of any of aspects 15-21, further includes that one of the UCI is multiplexed with the PUSCH based on a first rule on a first condition that the CC associated with the UCI is configured with a single CORESET pool index, a single TAG, or a PUCCH resource for a single TCI state; or the UCI is multiplexed with the PUSCH based on a second rule on a second condition that the CC associated with the UCI is configured with multiple CORESET pool indexes, multiple TAGs, or multiple PUCCH resources for multiple TCI states.

Aspect 23 is the method of any of aspects 15-22, further includes that a first PUSCH of the multiple overlapping PUSCHs includes AP-CSI, wherein one of the UCI is multiplexed on the first PUSCH further based on the first PUSCH comprising the AP-CSI and being associated with a same CORESET pool index as the UCI; or avoiding scheduling the UCI to overlap in the time domain with the first PUSCH having a different CORESET pool index than the UCI.

Aspect 24 is the method of any of aspects 15-23, further includes that a first PUSCH of the multiple overlapping PUSCHs includes AP-CSI, wherein the UCI is multiplexed the UCI on the first PUSCH further based on the first PUSCH comprising the AP-CSI and being associated with a different CORESET pool index than the UCI.

Aspect 25 is the method of any of aspects 15-24, further includes that at least two of the multiple overlapping PUSCHs include AP-CSI, wherein one of the UCI is multiplexed on the PUSCH associated with a same CORESET pool index as the UCI; or the UCI is multiplexed on the PUSCH associated with a defined CORESET pool index.

Aspect 26 is an apparatus for wireless communication at a network entity including at least one processor coupled to a memory and at least one transceiver, the at least one processor configured to implement any of Aspects 15-25.

Aspect 27 is an apparatus for wireless communication at a network entity including means for implementing any of Aspects 15-25.

Aspect 28 is a computer-readable medium storing computer executable code, where the code when executed by a processor causes the processor to implement any of Aspects 15-25.

Aspect 29 is an apparatus for wireless communication at a UE including at least one processor coupled to a memory, the at least one processor configured to implement any of Aspects 1-11.

Aspect 30 is an apparatus for wireless communication at a network entity including at least one processor coupled to a memory, the at least one processor configured to implement any of Aspects 15-25.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration for multiple downlink control information (DCI) operation including associations with control resource sets (CORESETs) configured for the UE, the associations including:
CORESET pool index 0 or an absence of a CORESET pool index, and
CORESET pool index 1; and
transmit uplink control information (UCI) multiplexed with a physical uplink shared channel (PUSCH) from multiple overlapping PUSCHs that overlap in a time domain on one or more carriers and overlap in the time domain with the UCI, the UCI multiplexed with the PUSCH based on at least one of a type of the UCI, content of the UCI, a feedback mode, or a carrier configuration.

2. The apparatus of claim 1, further comprising a transceiver coupled to the at least one processor.

3. The apparatus of claim 1, wherein the UCI is multiplexed with the PUSCH from the multiple overlapping PUSCHs based on the type of the UCI or the content of the UCI.

4. The apparatus of claim 3, wherein the at least one processor is configured to:
multiplex the UCI with the PUSCH based on a first rule on a first condition that the content of the UCI includes a hybrid automatic repeat request acknowledgement (HARQ-ACK) associated with multiple CORESET pool indexes of multiple groups or the UCI does not include the HARQ-ACK; or
multiplex the UCI with the PUSCH based on a second rule on a second condition that the content of the UCI includes the HARQ-ACK associated with a single CORESET pool index.

5. The apparatus of claim 1, wherein the UCI is multiplexed with the PUSCH from the multiple overlapping PUSCHs based on the feedback mode.

6. The apparatus of claim 5, wherein the at least one processor is configured to:
multiplex the UCI with the PUSCH based on a first rule on a first condition that the UE is configured with a joint acknowledgement (ACK) negative acknowledgement (NACK) feedback mode; or
multiplex the UCI with the PUSCH based on a second rule on a second condition that the UE is configured with a separate ACK NACK feedback mode.

7. The apparatus of claim 5, wherein in an absence of a configured acknowledgement (ACK) negative acknowledgement (NACK) feedback mode, the at least one processor is further configured to multiplex the UCI with the PUSCH based on one of:
a first rule applied for a joint ACK NACK feedback mode,
a second rule applied for a separate ACK NACK feedback mode, or
a rule based on the type of the UCI or the content of the UCI.

8. The apparatus of claim 1, wherein the UCI is multiplexed with the PUSCH from the multiple overlapping PUSCHs based on the carrier configuration for a component carrier (CC) associated with the UCI.

9. The apparatus of claim 8, wherein the at least one processor is configured to:
multiplex the UCI with the PUSCH based on a first rule on a first condition that the CC associated with the UCI is configured with a single CORESET pool index, a single timing advance group (TAG), or a physical uplink control channel (PUCCH) resource for a single transmission configuration indicator (TCI) state; or
multiplex the UCI with the PUSCH based on a second rule on a second condition that the CC associated with the UCI is configured with multiple CORESET pool indexes, multiple TAGs, or multiple PUCCH resources for multiple TCI states.

10. The apparatus of claim 1, wherein a first PUSCH of the multiple overlapping PUSCHs includes aperiodic channel state information (AP-CSI), wherein the at least one processor is configured to:
multiplex the UCI on the first PUSCH further based on the first PUSCH comprising the AP-CSI and being associated with a same CORESET pool index as the UCI;
drop the UCI based on the first PUSCH being associated with a different CORESET pool index than the UCI; or
identify an error case based on an overlap in the time domain of the UCI with the first PUSCH having the different CORESET pool index than the UCI.

11. The apparatus of claim 1, wherein a first PUSCH of the multiple overlapping PUSCHs includes aperiodic channel state information (AP-CSI), wherein the at least one processor is configured to:
multiplex the UCI on the first PUSCH further based on the first PUSCH comprising the AP-CSI and being associated with a different CORESET pool index than the UCI.

12. The apparatus of claim 1, wherein at least two of the multiple overlapping PUSCHs include aperiodic channel state information (AP-CSI), wherein the at least one processor is configured to:
multiplex the UCI on the PUSCH associated with a same CORESET pool index as the UCI; or
multiplex the UCI on the PUSCH associated with a defined CORESET pool index.

13. A method of wireless communication at a UE, comprising:
receiving a configuration for multiple downlink control information (DCI) operation including associations with control resource sets (CORESETs) configured for the UE, the associations including:
CORESET pool index 0 or an absence of a CORESET pool index, and
CORESET pool index 1; and
transmitting uplink control information (UCI) multiplexed with a physical uplink shared channel (PUSCH) from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

14. The method of claim 13, wherein the UCI is multiplexed with the PUSCH from the multiple overlapping PUSCHs based on the type of the UCI or the content of the UCI, further comprising:
multiplexing the UCI with the PUSCH based on a first rule on a first condition that the content of the UCI includes a hybrid automatic repeat request acknowledgement (HARQ-ACK) associated with multiple CORESET pool indexes of multiple groups or the UCI does not include the HARQ-ACK; or
multiplexing the UCI with the PUSCH based on a second rule on a second condition that the content of the UCI includes the HARQ-ACK associated with a single CORESET pool index.

15. The method of claim 13, wherein the UCI is multiplexed with the PUSCH from the multiple overlapping PUSCHs based on the feedback mode, further comprising:
multiplexing the UCI with the PUSCH based on a first rule on a first condition that the UE is configured with a joint acknowledgement (ACK) negative acknowledgement (NACK) feedback mode; or
multiplexing the UCI with the PUSCH based on a second rule on a second condition that the UE is configured with a separate ACK NACK feedback mode.

16. An apparatus for wireless communication at a network node, comprising:
a memory; and
at least one processor coupled to the memory and, based at least in part on information stored in the memory, the at least one processor is configured to:
provide configuration for multiple downlink control information (DCI) operation for a user equipment (UE) including associations with control resource sets (CORESETs) configured for the UE, the associations including:
CORESET pool index 0 or an absence of a CORESET pool index, and
CORESET pool index 1; and
receive uplink control information (UCI) multiplexed with a physical uplink shared channel (PUSCH) from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

17. The apparatus of claim 16, further comprising a transceiver coupled to the at least one processor.

18. The apparatus of claim 16, wherein the UCI is multiplexed with the PUSCH from the multiple overlapping PUSCHs based on the type of the UCI or the content of the UCI.

19. The apparatus of claim 18, wherein one of:
the UCI is multiplexed with the PUSCH based on a first rule on a first condition that the content of the UCI includes a hybrid automatic repeat request acknowledgement (HARQ-ACK) associated with multiple CORESET pool indexes of multiple groups or the UCI does not include the HARQ-ACK; or
the UCI is multiplexed with the PUSCH based on a second rule on a second condition that the content of the UCI includes the HARQ-ACK associated with a single CORESET pool index.

20. The apparatus of claim 16, wherein the UCI is multiplexed with the PUSCH from the multiple overlapping PUSCHs based on the feedback mode.

21. The apparatus of claim 20, wherein one of:
the UCI is multiplexed with the PUSCH based on a first rule on a first condition that the UE is configured with a joint acknowledgement (ACK) negative acknowledgement (NACK) feedback mode; or
the UCI is multiplexed with the PUSCH based on a second rule on a second condition that the UE is configured with a separate ACK NACK feedback mode.

22. The apparatus of claim 20, wherein an acknowledgement (ACK) negative acknowledgement (NACK) feedback mode is not configured, and wherein the UCI is multiplexed with the PUSCH based on one of:
a first rule applied for a joint ACK NACK feedback mode,
a second rule applied for a separate ACK NACK feedback mode, or
a rule based on the type of the UCI or the content of the UCI.

23. The apparatus of claim 16, wherein the UCI is multiplexed with the PUSCH from the multiple overlapping PUSCHs based on the carrier configuration for a component carrier (CC) associated with the UCI.

24. The apparatus of claim 23, wherein one of:
the UCI is multiplexed with the PUSCH based on a first rule on a first condition that the CC associated with the UCI is configured with a single CORESET pool index, a single timing advance group (TAG), or a physical uplink control channel (PUCCH) resource for a single transmission configuration indicator (TCI) state; or
the UCI is multiplexed with the PUSCH based on a second rule on a second condition that the CC associated with the UCI is configured with multiple CORESET pool indexes, multiple TAGs, or multiple PUCCH resources for multiple TCI states.

25. The apparatus of claim 16, wherein a first PUSCH of the multiple overlapping PUSCHs includes aperiodic channel state information (AP-CSI), wherein one of:
the UCI is multiplexed on the first PUSCH further based on the first PUSCH comprising the AP-CSI and being associated with a same CORESET pool index as the UCI; or
avoiding scheduling the UCI to overlap in the time domain with the first PUSCH having a different CORESET pool index than the UCI.

26. The apparatus of claim 16, wherein a first PUSCH of the multiple overlapping PUSCHs includes aperiodic channel state information (AP-CSI), wherein the UCI is multiplexed the UCI on the first PUSCH further based on the first PUSCH comprising the AP-CSI and being associated with a different CORESET pool index than the UCI.

27. The apparatus of claim 16, wherein at least two of the multiple overlapping PUSCHs include aperiodic channel state information (AP-CSI), wherein one of:
the UCI is multiplexed on the PUSCH associated with a same CORESET pool index as the UCI; or
the UCI is multiplexed on the PUSCH associated with a defined CORESET pool index.

28. A method of wireless communication at a network node, comprising:
providing configuration for multiple downlink control information (DCI) operation for a user equipment (UE) including associations with control resource sets (CORESETs) configured for the UE, the associations including:
CORESET pool index 0 or an absence of a CORESET pool index, and
CORESET pool index 1; and
receiving uplink control information (UCI) multiplexed with a physical uplink shared channel (PUSCH) from multiple overlapping PUSCHs that overlap in a time domain on a same carrier and overlap in the time domain with the UCI, the UCI multiplexed with the PUSCH based on at least one of a type of the UCI, content of the UCI, a feedback mode or a carrier configuration.

29. The method of claim 28, wherein the UCI is multiplexed with the PUSCH from the multiple overlapping PUSCHs based on the type of the UCI or the content of the UCI, wherein one of:
the UCI is multiplexed with the PUSCH based on a first rule on a first condition that the content of the UCI includes a hybrid automatic repeat request acknowledgement (HARQ-ACK) associated with multiple CORESET pool indexes of multiple groups or the UCI does not include the HARQ-ACK; or
the UCI is multiplexed with the PUSCH based on a second rule on a second condition that the content of the UCI includes the HARQ-ACK associated with a single CORESET pool index.

30. The method of claim 28, wherein the UCI is multiplexed with the PUSCH from the multiple overlapping PUSCHs based on the feedback mode, wherein one of:
the UCI is multiplexed with the PUSCH based on a first rule on a first condition that the UE is configured with a joint acknowledgement (ACK) negative acknowledgement (NACK) feedback mode; or
the UCI is multiplexed with the PUSCH based on a second rule on a second condition that the UE is configured with a separate ACK NACK feedback mode.
